(19) United States
(12) Patent Application Publication
(10) Pub. No.: US 2004/0124808 A1
(43) Pub. Date: Jul. 1, 2004

(54) Motor control system

(76) Inventor: Daisuke Hirono, Isesaki-shi (JP)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 10/725,268

(22) Filed: Dec. 2, 2003

(30) Foreign Application Priority Data
Dec. 26, 2002 (JP) 2002/376477

(51) Int. Cl. H02P 5/28

(52) U.S. Cl. 318/806

(57) ABSTRACT

A motor control system includes a control section that performs operating range limiting processing in which a junction temperature of switching element of an electric power converter is calculated and compared with a preset temperature limit, and when the junction temperature exceeds the temperature limit, junction temperature reduction processing is performed to make the junction temperature equal to or less than the temperature limit, whereby the switching elements can effectively used to their maximum temperature limit irrespective of a temperature detected by a temperature sensor, thus expanding the operating range of a motor.

### BACKGROUND OF THE INVENTION

1. Technical Field

The present invention relates to a motor control system for driving a motor with a PWM control using an electric power converter such as a three-phase inverter, etc.

2. Related Art

FIG. 1 shows an example of a conventionally known motor control system described in, e.g., JP-A-2002-186171, in which reference numeral 101 denotes a three-phase brushless motor; 102, inverter section; 103, DC power source; 104, drive section; 105, control section; 106, temperature sensor; and 107, temperature sensing section.

The inverter section 102 has three pairs of switching elements Us, Xs; Vs, Ys; Ws, Zs, each of which is constituted by a transistor, etc. In accordance with drive signals supplied from the drive section 104, the switching elements Us, Xs; Vs, Ys; Ws, Zs are on/off controlled, so that the inverter section 102 may convert a DC power supplied from the DC power source 103 into pseudo three-phase AC power that is output to coil phases Uc, Vc, Wc of the motor 101.

The control section 105 is constituted by a microcomputer, etc., and carries out PWM signal generating processing for generating a PWM signal to attain a predetermined motor rotational speed in accordance with a rotational speed command and for outputting the generated PWM signal to the drive section 104; motor rotational speed feedback processing for calculating a current motor rotational speed on axis position data supplied from an axis position detecting section 108 and for controlling the current motor rotational speed to be equal to the predetermined motor rotational speed corresponding to the rotational speed command; and the later-mentioned heat protection processing.

The temperature sensor 106 detects a temperature of the switching elements Us-Zs of the inverter section 102. The temperature detecting section 107 carries out an A/D conversion of a temperature detection signal, and delivers the A/D converted signal to the control section 105. The temperature sensor 106 is comprised of a sensor, using thermistor, etc., that is disposed at a location where the temperature of the switching elements can be detected, e.g., in the vicinity of the switching elements mounted on a base plate, or on a surface of a switching element package, or the like.

The axis position sensor 108 detects the position of a rotor of the motor 101. The axis position detecting section 109 makes an A/D conversion of a position detection signal, and delivers the A/D converted signal to the control section 105. The axis position sensor 108 is constituted by a resolver, rotary encoder, or the like, and has its detecting element coupled to the rotor of the motor 101.

The temperature sensor 106 is provided for heat protection of the switching elements of the inverter section 102. In the aforementioned motor control system, a control to stop the motor 101 is performed when a temperature detected by the temperature sensor 106 exceeds the upper limit of a preset allowable temperature range.

With the just-mentioned motor control system that is designed to perform the heat protection processing solely based on a temperature detected by the temperature sensor 106, the motor 101 can be forcibly stopped from operating even in a temperature state where the switching elements Us-Zs can in actual fact operate without problems. Thus, the ability of the switching elements in itself cannot be fully utilized, resulting in a disadvantage that a motor operating range can be unnecessarily narrowed.

### SUMMARY OF THE INVENTION

An object of the present invention is to provide a motor control system capable of expanding a motor operating range by using switching elements of an electric power converter such as a three-phase inverter to their thermal limit.

According to one aspect of this invention, there is provided a motor control system for driving a motor with a PWM control using an electric power converter such as a three-phase inverter, etc. This motor control system comprises junction temperature calculating means for calculating a junction temperature of a switching element of the electric power converter; and junction temperature reducing means for comparing the junction temperature calculated by the junction temperature calculating means with a preset temperature limit and for performing junction temperature reduction processing to make the junction temperature equal to or less than the temperature limit when the junction temperature exceeds the temperature limit.

According to the motor control system, a calculated junction temperature is compared with the preset temperature limit, and when the junction temperature exceeds the temperature limit, the junction temperature reduction processing is performed to make the junction temperature equal to or less than the temperature limit. Therefore, the switching element can effectively be used to its maximum temperature limit irrespective of the detected temperature, making it possible to expand the motor operating range.

A motor control system according to another aspect of this invention is a motor control system for driving a motor with a PWM control using an electric power converter such as a three-phase inverter, etc., which mainly comprises loss calculating means for calculating a loss of a switching element of the electric power converter; and loss reducing means for comparing the loss calculated by the loss calculating means with a preset loss limit and for performing loss reduction processing to make the loss equal to or less than the loss limit when the loss exceeds the loss limit.

According to this motor control system, a calculated loss and the preset loss limit are compared with each other, and when the loss exceeds the loss limit, the loss reduction processing is performed to make the loss equal to or less than the loss limit. Therefore, the switching element can effectively be used to its maximum temperature limit irrespective of the detected temperature, making it possible to expand the motor operating range.

A motor control system according to still another aspect of this invention is a motor control system for driving a motor with a PWM control using an electric power converter such as a three-phase inverter, etc., which mainly comprises temperature detecting means for detecting a temperature of a switching element of the electric power converter; junction temperature calculating means for calculating a junction temperature of the switching element of the electric power converter when the temperature detected by the temperature detecting means is between a maximum temperature limit of the switching element and a predetermined temperature which is lower than the maximum temperature limit; junction temperature reducing means for comparing the junction temperature calculated by the junction temperature calculating means with a preset temperature limit when the temperature detected by the temperature detecting means is between the maximum temperature limit of the switching element and the predetermined temperature which is lower than the maximum temperature limit and for performing junction temperature reduction processing when the junction temperature exceeds the temperature limit; loss calculating means for calculating a loss of the switching element of the electric power converter when the temperature detected by the temperature detecting means is equal to or less than the predetermined temperature; and loss reducing means for comparing the loss calculated by the loss calculating means with a preset loss limit when the temperature detected by the temperature detecting means is equal to or less than the predetermined temperature and for performing loss reduction processing to make the loss equal to or less than the loss limit when the loss exceeds the loss limit.

According to this motor control system, when a temperature detected by the temperature detecting means is between the maximum temperature limit of the switching element and the predetermined temperature which is lower than the maximum temperature limit, the preset temperature limit is compared with the calculated junction temperature, and when the junction temperature exceeds the temperature limit, the junction temperature reduction processing is performed to make the junction temperature equal to or less than the temperature limit. On the other hand, when the temperature detected by the temperature detecting means is equal to or less than the predetermined temperature, the preset loss limit is compared with a calculated loss, and when the loss exceeds the loss limit, the loss reduction processing is performed to make the loss equal to or less than the loss limit. Therefore, the switching element can effectively be used to its maximum temperature limit irrespective of the detected temperature, making it possible to expand the motor operating range.

A motor control system according to a further aspect of this invention is a motor control system for driving a motor with a PWM control using an electric power converter such as a three-phase inverter, etc., which mainly comprises loss calculating means for calculating a loss of a switching element of the electric power converter; junction temperature calculating means for calculating a junction temperature of the switching element of the electric power converter; loss reducing means for comparing the loss calculated by the loss calculating means with a preset loss limit and for performing loss reduction processing to make the loss equal to or less than the loss limit when the loss exceeds the loss limit; and junction temperature reducing means for comparing, when it is determined by said comparison that the loss is equal to or less than the loss limit or when the loss becomes equal to or less than the loss limit by the loss reduction processing, the junction temperature calculated by the junction temperature calculating means with a preset temperature limit and for performing junction temperature reduction processing to make the junction temperature equal to or less than the temperature limit when the junction temperature exceeds the temperature limit.

According to this motor control system, a loss calculated by the loss calculating means is compared with the preset loss limit, and when the loss exceeds the loss limit, the loss reduction processing is performed to make the loss equal to or less than the loss limit. When it is determined by the comparison that the loss is equal to or less than the loss limit or when the loss becomes equal to or less than the loss limit by the loss reduction processing, a junction temperature calculated by the junction temperature calculating means is compared with the preset temperature limit, and when the junction temperature exceeds the temperature limit, the junction temperature reduction processing is performed to make the junction temperature equal to or less than the temperature limit. Therefore, the switching element can effectively be used to its maximum temperature limit irrespective of the detected temperature, making it possible to expand the motor operating range.

The above object and other objects, structural features, functions, and advantages of this invention will be apparent from the following description and appended drawings.

### BRIEF DESCRIPTION OF THE DRAWINGS

FIG. 1 is a block diagram showing a conventionally known motor control system;

FIG. 2 is a block diagram showing a motor control system according to the present invention;

FIG. 3 is a flowchart showing a first operating range limiting method executed in the motor control system shown in FIG. 2;

FIG. 4 is a view showing an operational range of switching elements according to the first operating range limiting method;

FIGS. 5A and 5B are views for explaining a method for reducing the number of switchings according to the first operating range limiting method;

FIG. 6 is a flowchart showing a second operating range limiting method executed in the motor control system shown in FIG. 2:

FIG. 7 is a view showing an operating range of switching elements according to the second operating range limiting method;

FIG. 8 is a flowchart showing a third operating range limiting method executed in the motor control system of FIG. 2;

FIG. 9 is a view showing an operating range of switching elements according to the third operating range limiting method;

FIG. 10 is a flowchart showing a fourth operating range limiting method executed in the motor control system of FIG. 2; and

FIG. 11 is a view showing an operating range of switching elements according to the fourth operating range limiting method.

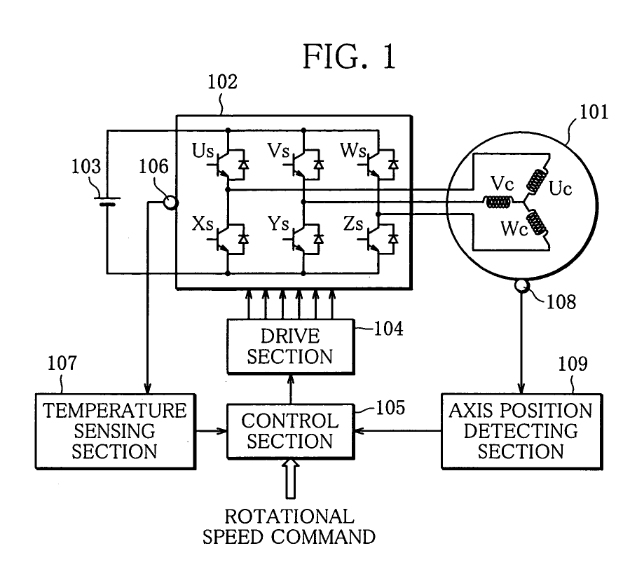

### DETAILED DESCRIPTION

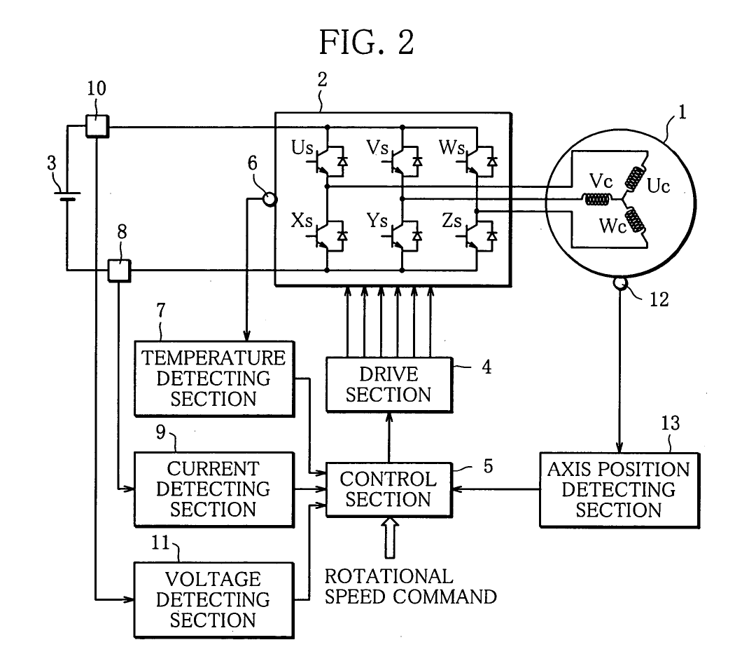

FIG. 2 shows an embodiment of a motor control system according to the present invention, in which reference numeral 1 denotes a three-phase brushless motor; 2, inverter section; 3, DC power source; 4, drive section; 5, control section; 6, temperature sensor; 7, temperature detecting section; 8, electric current sensor; 9, electric current detecting section; 10, voltage sensor; 11, voltage detecting section; 12, axis position sensor; and 13, axis position detecting section.

The inverter section 2 has three pairs of switching elements Us, Xs; Vs, Ys; Ws, Zs, each of which is constituted by a transistor or the like. These switching elements Us-Zs are on-off controlled based on drive signals supplied from the drive section 4, and the inverter section 2 converts a DC power into pseudo three-phase AC power that is output to coil phases Uc, Vc, Wc of the motor 1.

The control section 5 is constituted by a microcomputer, etc., and carries out PWM signal generating processing for generating a PWM signal to attain a predetermined motor rotational speed in accordance with a rotational speed command and for outputting the generated PWM signal to the drive section 4; motor rotational speed feedback processing for calculating a motor rotational speed at the present time based on axis position data supplied from an axis position detecting section 13 and for controlling the present motor rotational speed to be equal to the predetermined motor rotational speed corresponding to the rotational speed command; and the later-mentioned operating range limiting processing.

The temperature sensor 6 detects a temperature of the switching elements Us-Zs of the inverter section 2. The temperature detecting section 7 carries out an A/D conversion of a temperature detection signal, and delivers the A/D converted signal to the control section 5. The temperature sensor 6 is comprised of a sensor, using thermistor, etc., that is disposed at a location where the temperature of the switching elements can be detected, e.g., in the vicinity of the switching elements mounted on a base plate, or on a surface of a switching element package, or the like.

The current sensor 8 detects an electric current flowing from the DC power source 3 to the inverter section 2. The current detecting section 9 makes an A/D conversion of a current detection signal, and delivers the A/D converted signal to the control section 5. The current sensor 8 is constituted by a known sensor using a shunt resistor or the like, and is provided in a power wire extending from the DC power source 3 to the inverter section 2.

The voltage sensor 10 detects a voltage applied from the DC power source 3 to the inverter section 2. The voltage detecting section 11 makes an A/D conversion of a voltage detection signal, and delivers the A/D converted signal to the control section 5. The voltage sensor is constituted by a known sensor using a voltage dividing resistor or the like, and is provided in a power wire extending from the DC power source 3 to the inverter section 2.

The axis position sensor 12 detects a position of a rotor of the motor 1. The axis position detecting section 13 makes an A/D conversion of a detected signal, and delivers the A/D converted signal to the control section 5. The axis position sensor 12 is constituted by a resolver, rotary encoder, or the like, and has its detecting element coupled to the rotor of the motor 1. Meanwhile, the axis position sensor 12 may be omitted in a case where the motor 1 is of a sensorless type that is not provided with the axis position sensor 12, where a sensor is provided for detecting phase currents that are output from the inverter section 2 to the coil phases of the motor 1 or for detecting the phase currents and phase voltages, and where based on signals supplied from this sensor, the control section 5 performs processing to calculate the motor rotational speed.

Next, operating range limiting processing executed by the motor control system will be described.

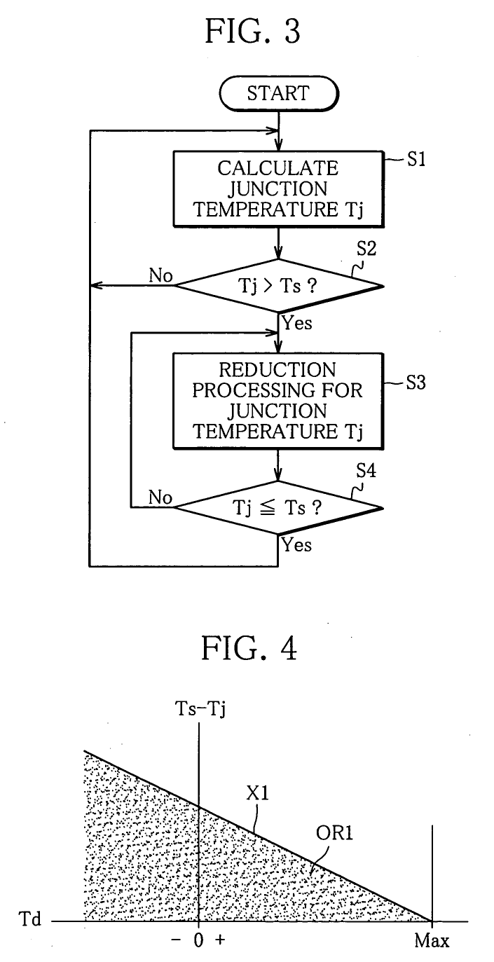

FIGS. 3 and 4 show a first operating range limiting method, where FIG. 3 is a flowchart of the operating range limiting processing, and FIG. 4 is a view showing an operating range of switching elements.

In FIG. 4, Td denotes a temperature detected by the temperature sensor 6; Ts−Tj, a value obtained by subtracting a calculated junction temperature Tj of the switching elements from a predetermined temperature limit Ts; X1, a junction temperature limit line; and OR1, an operating range (dot-meshed portion in FIG. 4) of the switching elements formed below the junction temperature limit line X1. The junction temperature limit line X1 extends, with a left-upward gradient, from the maximum temperature limit Max, e.g., 150 degree centigrade, to a lower temperature zone.

The first operating range limiting method is characterized in that the junction temperature Tj of the switching elements Us-Zs is calculated, and a control is made such that the calculated junction temperature Tj is within the operating range OR1 shown in FIG. 4.

Specifically, as shown in the flowchart of FIG. 3, the junction temperature TI of the switching elements Us-Zs at the present time is calculated in accordance with the following formula (step S1):

Tj=Td+(Rh×Lo), Formula 1

where Td denotes a temperature detected by the temperature sensor 6; Rh, a thermal resistance (degree centigrade per watt) between the temperature sensor 6 and junctions of the switching elements Us-Zs; and Lo, a loss in the switching elements Us-Zs.

The thermal resistance Rh in formula 1 is known from the specification of the temperature sensor 6 and switching elements Us-Zs. The loss Lo in formula 1 is the sum of a loss Lo1 caused when the switching elements Us-Zs are turned on or off and a loss Lo2 caused by an electric current flowing through the switching elements (Lo 32 Lo1+Lo2). The loss Lo1 can be calculated in accordance with the following formula:

Lo1=Ns×f(voltage, current), Formula 2

where Ns denotes the number of switchings per unit time, and f(voltage, current) denotes a function of voltage and current, and can be represented as f=α (constant)×voltage×function. The number of switchings Ns can be determined based on a control signal for PWM signal generation which is supplied from the control section 5 to the drive section 4, the current can be determined based on current data supplied from the current detecting section 9 to the control section 5, and the voltage can be determined based on voltage data supplied from the voltage detecting section 11 to the control section 5.

The way of determining the Lo2 varies whether FETs or transistors or IGBTs are used as the switching elements. For a case where FETs are used, the Lo2 can be calculated from the following formula:

Lo2=Rs×Is², Formula 3

whereas for a case where transistors or IGBTs are used, it can be calculated from the following formula:

Lo2=Vcesat×Is. Formula 4

Symbol Rs and Is in Formula 3 denote a resistance of the switching elements Us-Zs and an electric current flowing through the switching elements Us-Zs, respectively. The resistance Rs can be determined in advance based on the specification of the switching elements Us-Zs, and the electric current Is can be determined based on current data supplied from the current detecting section 9 to the control section 5. In formula 4, Vcesat can be determined based on voltage data supplied from the voltage detecting section 11 to the control section 5, and the electric current Is can be determined based on current data supplied from the current detecting section 9 to the control section 5.

Next, a comparison is made between the temperature limit Ts prescribed by the junction temperature limit line X1 in FIG. 4 and the junction temperature Tj obtained by calculation (step S2). If Tj≦Ts, the flow returns to step Si. If Tj>Ts, the reduction processing for the junction temperature Tj is carried out (step S3). The temperature limit Ts is set in advance depending on the specification of the switching elements Us-Zs, which is 150 degree centigrade, for instance.

The junction temperature Tj reduction processing is performed by a method of reducing the loss Lo in formula 1, more specifically, by either one or both of a method of reducing the number of switchings Ns in formula 2 and a method of reducing the electric current Is in formula 3 or 4.

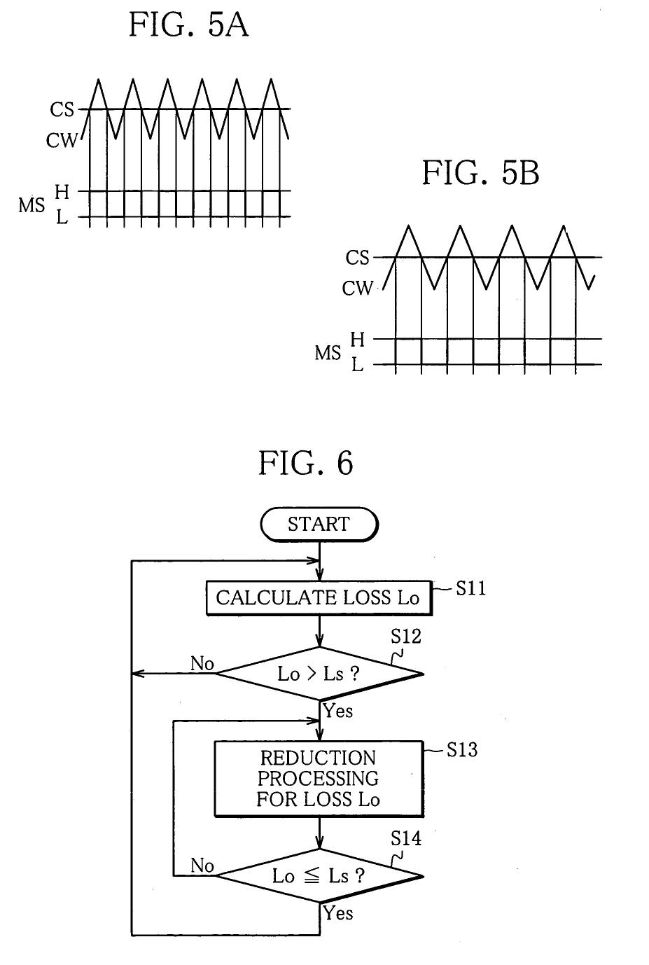

The number of switchings Ns can be reduced by lowering the frequency of a base carrier that is used for generation of a PWM signal from which a predetermined motor rotational speed is attained. In a PWM method where a PWM signal MS is generated by superimposing an output setting signal CS on the base carrier (triangular wave) CW as shown in FIG. 5A, the number of switchings Ns can be reduced by lowering the frequency of the base modulating wave CW as shown in FIG. 5B. In this case, although the frequency of the base modulating wave CW lowers, the effective voltage value of the output signal MS does not change, so that the motor rotational speed is kept unchanged.

The electric current Is can be reduced by decreasing the duty ratio of the generated PWM signal. In case the PWM signal is generated as shown in FIG. 5A, the current Is can be reduced by narrowing a time width of a high-level portion of the generated PWM signal MS. In this case, the effective voltage value of the output signal MS decreases, and thus the motor rotational speed decreases.

When the relation of Tj≦Ts is satisfied by performing the junction temperature Tj reduction processing (step S4), the flow returns to step S1. Subsequently, similar procedures are repeated.

According to the first operating range limiting method, the preset temperature limit Ts is compared with the calculated junction temperature Tj, and if there is a relation of Tj>Ts, the junction temperature Tj reduction processing is performed such that the relation of Tj≦Ts is satisfied. Therefore, the operating range of the motor 1 can be expanded by effectively using the switching elements Us-Zs to their maximum temperature limit Max irrespective of the detected temperature Td.

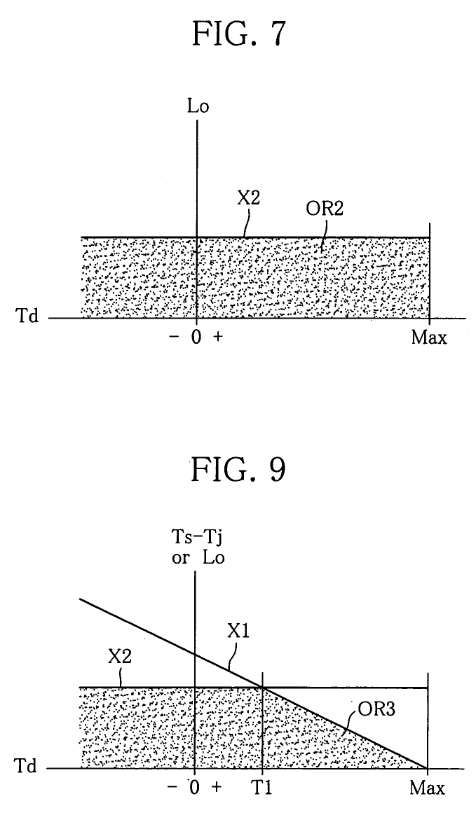

FIGS. 6 and 7 show a second operating range limiting method, where FIG. 6 is a flowchart of the operating range limiting processing, and FIG. 7 is a view showing an operating range of the switching elements.

In FIG. 7, Td denotes a temperature detected by the temperature sensor 6; Lo, a loss of the switching element obtained by calculation; X2, a loss limit line; and OR2, an operating range (dot-meshed portion in FIG. 7) of the switching elements formed below the loss limit line X2. The junction temperature limit line X2 has a constant value in a range from the maximum temperature limit Max, e.g., 150 degree centigrade, to a lower temperature zone.

The second operating range limiting method is characterized in that a loss Lo of the switching elements Us-Zs is calculated, and a control is made such that the calculated loss Lo is within the operating range OR2 shown in FIG. 7.

Specifically, as shown in the flowchart of FIG. 6, a loss Lo of the switching elements Us-Zs at the present time is calculated (step S11). The loss Lo is the sum of a loss Lo1 caused when the switching elements Us-Zs are turned on or off and a loss Lo2 caused by an electric current flowing through the switching elements (Lo=Lo1+Lo2). The Lo1 can be determined from formula 1, and the Lo2 can be determined from formula 3 or 4.

Next, a comparison is made between the loss limit Ls prescribed by the loss limit line X2 in FIG. 7 and the loss Lo obtained by calculation (step S12). If Lo≦Ls, the flow returns to step S11. If Lo>Ls, the reduction processing for the loss Lo is carried out (step S13). The loss limit Ls is set in advance depending on the specification of the switching elements Us-Zs.

The loss Lo reduction processing is performed by either one or both of a method of reducing the number of switchings Ns in formula 2 and a method of reducing the electric current Is in formula 3 or 4. As for the methods of reducing the number of switching Ns and the electric current Is, they are the same as those described above and explanations thereon will be omitted.

When a relation of Lo≦Ls is satisfied by performing the loss Lo reduction processing (step S14), the flow returns to step S11. Subsequently, similar procedures are repeated.

According to the second operating range limiting method, the preset loss limit Ls and the calculated loss Lo are compared with each other, and if there is a relation of Lo>Ls, the loss Lo reduction processing is performed such that the relation of Lo≦Ls is satisfied. Therefore, the operating range of the motor 1 can be expanded by-effectively using the switching elements Us-Zs to their maximum temperature limit Max irrespective of the detected temperature Td.

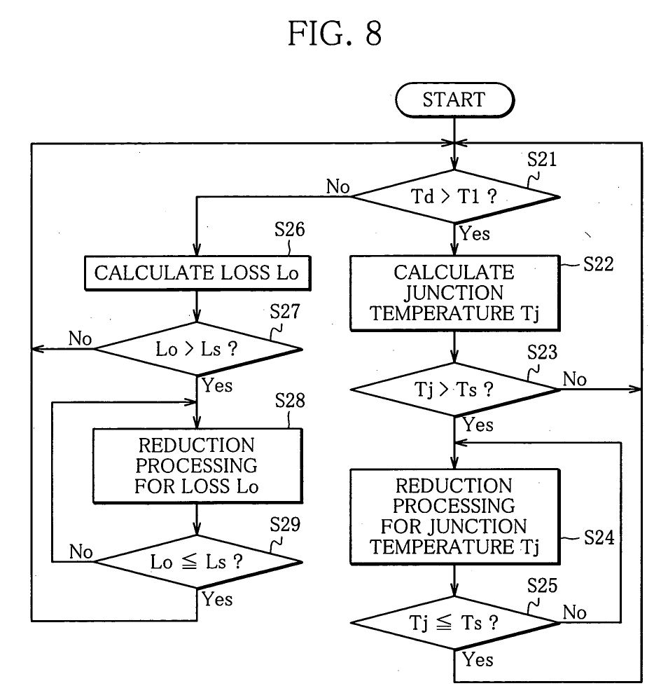

FIGS. 8 and 9 show a third operating range limiting method, where FIG. 8 is a flowchart of the operating range limiting processing, and FIG. 9 is a view showing an operating range of the switching elements.

In FIG. 9, Td denotes a temperature detected by the temperature sensor 6; Ts−Tj, a value obtained by subtracting a calculated junction temperature Tj of the switching elements from a predetermined temperature limit Ts; Lo, a loss of the switching elements obtained by calculation; X1, a junction temperature limit line; X2, a loss limit line; and OR3, an operating range (dot-meshed portion in FIG. 9) of the switching elements formed below the junction temperature limit line X1 and the loss limit line X2. The junction temperature limit line X1 extends, with a left-upward gradient, from the maximum temperature limit Max, e.g., 150 degree centigrade, to a lower temperature zone. The junction temperature limit line X2 has a constant value in a range from the maximum temperature limit Max, e.g., 150 degree centigrade, to a lower temperature zone.

The third operating range limiting method is characterized in that a junction temperature Tj of the switching elements Us-Zs is calculated when a temperature Td detected by the temperature sensor 6 is between the maximum temperature limit Max and a predetermined temperature T1, and a control is made such that the calculated junction temperature Tj is located the right side of the T1 in the operating range OR3 shown in FIG. 9. When the temperature Td detected by the temperature sensor 6 is equal to or less than the predetermined temperature T1, a loss Lo of the switching elements Us-Zs is calculated, and a control is made such that the calculated loss Lo is located the left side of the T1 in the operating range OR3 shown in FIG. 9.

Specifically, as shown in the flowchart of FIG. 8, a temperature Td detected by the temperature sensor 6 is compared with the predetermined temperature T1 (step S21). When there is a relation of Td>T1, the flow advances to step S22. When there is a relation of Td≦T1, the flow advances to step S26.

If Td>T1, the junction temperature Tj of the switching elements Us-Zs at the present time is calculated in accordance with formula 1 (step S22). The loss Lo in formula 1 is the sum of a loss Lo1 caused when the switching elements Us-Zs are turned on or off and a loss Lo2 caused by an electric current flowing through the switching elements (Lo=Lo1+Lo2). The Lo1 and Lo2 can be determined in accordance with formula 2 and formula 3 or 4, respectively.

Next, a comparison is made between the temperature limit Ts prescribed by the junction temperature limit line X1 in FIG. 9 and the junction temperature Tj obtained by the calculation (step S23). If Tj≦Ts, the flow returns to step S21. If Tj>Ts, the reduction processing for the junction temperature Tj is carried out (step S24). The temperature limit Ts is set in advance depending on the specification of the switching elements Us-Zs, which is 150 degree centigrade, for instance.

The junction temperature Tj reduction processing is performed by a method of reducing the loss Lo in formula 1, more specifically, by either one or both of a method of reducing the number of switchings Ns in formula 2 and a method of reducing the electric current Is in formula 3 or 4. As for the methods of reducing the number of switching Ns and the electric current Is, they are the same as those described above and explanations thereon will be omitted.

When a relation of Tj≦Ts is satisfied by performing the junction temperature Tj reduction processing (step S25), the flow returns to step S21. Subsequently, similar procedures are repeated.

On the other hand, if it is determined at step S21 that there is a relation of Td≦T1, a loss Lo of the switching elements Us-Zs at the present time is calculated (step S26). The loss Lo is the sum of a loss Lo1 caused when the switching elements Us-Zs are turned on or off and a loss Lo2 caused by an electric current flowing through the switching elements (Lo=Lo1+Lo2). The Lo1 and Lo2 can be determined in accordance with formula 1 and formula 3 or 4, respectively.

Next, a comparison is made between the loss limit Ls prescribed by the loss limit line X2 in FIG. 9 and the loss Lo obtained by the calculation (step S27). If Lo≦Ls, the flow returns to step S21. If Lo>Ls, the reduction processing for the loss Lo is carried out (step S28). The loss limit Ls is set in advance depending on the specification of the switching elements Us-Zs.

The loss Lo reduction processing is performed by either one or both of a method of reducing the number of switchings Ns in formula 2 and a method of reducing the electric current Is in formula 3 or 4. As for the methods of reducing the number of switching Ns and the electric current Is, they are the same as those described above and explanations thereon will be omitted.

When the relation of Lo≦Ls is satisfied by performing the loss Lo reduction processing (step S29), the flow returns to step S21. Subsequently, similar procedures are repeated.

According to the third operating range limiting method, when the temperature Td detected by the temperature sensor 6 is higher than the predetermined temperature T1 and is equal to or lower than the maximum temperature limit Max of the switching elements Us-Zs, the preset temperature limit Ts and the calculated junction temperature Tj are compared with each other, and if there is a relation of Tj>Ts, the reduction processing for junction temperature T1 is performed such that the relation of Tj≦Ts is satisfied. On the other hand, when the temperature Td detected by the temperature sensor 6 is equal to or less than the predetermined temperature T1, the preset loss limit Ls and the calculated loss Lo are compared with each other, and if there is a relation of Lo>Ls, the loss Lo reduction processing is performed such that the relation of Lo:Ls is satisfied. Therefore, the operating range of the motor 1 can be expanded by effectively using the switching elements Us-Zs to their maximum temperature limit Max irrespective of the detected temperature Td.

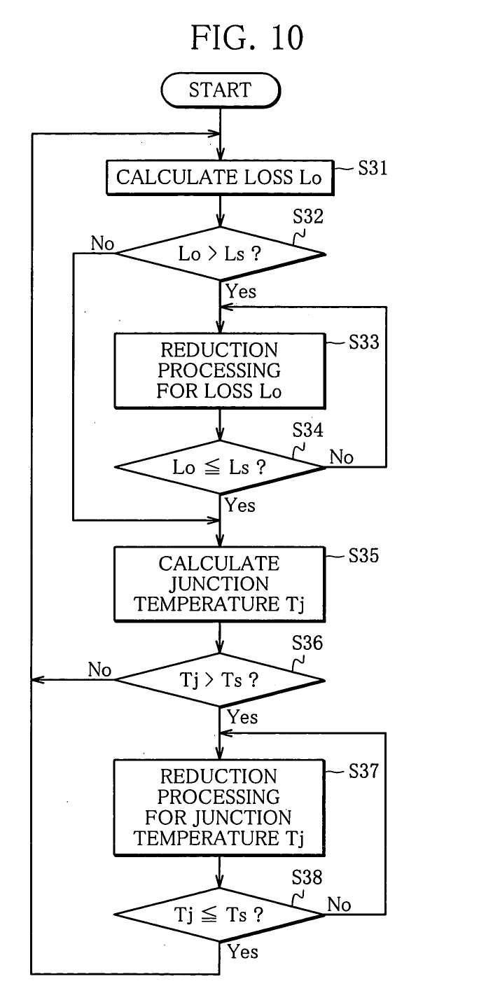

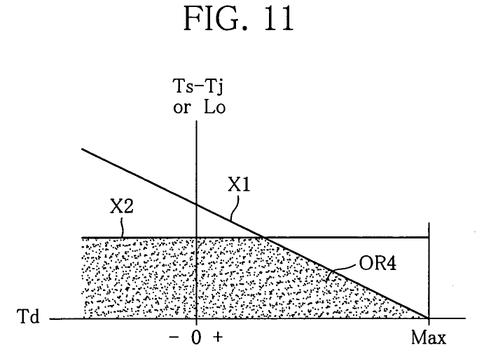

FIGS. 10 and 11 show a fourth operating range limiting method, where FIG. 10 is a flowchart of the operating range limiting processing, and FIG. 11 is a view showing an operating range of the switching elements.

In FIG. 11, Td denotes a temperature detected by the temperature sensor 6; Ts−Tj, a value obtained by subtracting a calculated junction temperature Tj of the switching elements from a predetermined temperature limit Ts; Lo, a loss of the switching element obtained by calculation; X1, a junction temperature limit line; X2, a loss limit line; and OR4, an operating range (dot-meshed portion in FIG. 11) of the switching elements formed below the junction temperature limit line X1 and the loss limit line X2. The junction temperature limit line X1 extends, with a left-upward gradient, from the maximum temperature limit Max, e.g., 150 degree centigrade, to a lower temperature zone. The junction temperature limit line X2 has a constant value in a range from the maximum temperature limit Max to a lower temperature zone. These limit lines X1 and X2 cross each other at a predetermined temperature T1, e.g., 25 degree centigrade that is lower than the maximum temperature limit Max.

The fourth operating range limiting method is characterized in that a loss Lo of the switching elements Us-Zs is calculated, and if the loss Lo is larger than the loss limit Ls, a control is made such that the calculated loss Lo is located in the operating range OR4 shown in FIG. 11. If the loss Lo is equal to or less than the loss limit Ls, the junction temperature Tj of the switching elements Us-Zs is calculated, and a control is made such that the junction temperature Tj is located in the operating range OR4 shown in FIG. 11.

Specifically, as shown in the flowchart of FIG. 10, a loss Lo of the switching elements Us-Zs at the present time is calculated (step S31). The loss Lo is the sum of a loss Lo1 caused by the switching elements Us-Zs being turned on/off and a loss Lo2 caused by an electric current flowing through the switching elements (Lo=Lo1+Lo2). The Lo1 and Lo2 can be determined in accordance with formula 1 and formula 3 or 4, respectively.

Next, a comparison is made between the loss limit Ls prescribed by the loss limit line X2 in FIG. 11 and the loss Lo obtained by the calculation (step S32). If Lo≦Ls, the flow returns to step S35. If Lo>Ls, the reduction processing for the loss Lo is carried out (step S33). The loss limit Ls is set in advance depending on the specification of the switching elements Us-Zs.

The loss Lo reduction processing is performed by either one or both of a method of reducing the number of switchings Ns in formula 2 and a method of reducing the electric current Is in formula 3 or 4. As for the methods of reducing the number of switching Ns and the electric current Is, they are the same as those described in the above and explanations thereon will be omitted.

When the relation of Lo≦Ls is satisfied by performing the loss Lo reduction processing (step S34) or when it is determined at step S32 that there is a relation of Lo≦Ls, a loss Lo of the switching elements Us-Zs at the present time is calculated in accordance with formula 1 (step S35). The loss Lo is the sum of a loss Lo1 caused when the switching elements Us-Zs are turned on or off and a loss Lo2 caused by an electric current flowing through the switching elements (Lo=Lo1+Lo2). The Lo1 and Lo2 can be determined in accordance with formula 1 and formula 3 or 4, respectively.

Next, a comparison is made between the temperature limit Ts prescribed by the junction temperature limit line X1 in FIG. 11 and the junction temperature Tj obtained by the calculation (step S36). If Tj≦Ts, the flow returns to step S31. If Tj>Ts, the reduction processing for the junction temperature Tj is carried out (step S37). The temperature limit Ts is set in advance depending on the specification of the switching elements Us-Zs, which is 150 degree centigrade, for instance.

The junction temperature Tj reduction processing is performed by a method of reducing the loss Lo in formula 1, more specifically, by either one or both of a method of reducing the number of switchings Ns in formula 2 and a method of reducing the electric current Is in formula 3 or 4. As for the methods of reducing the number of switching Ns and the electric current Is, they are the same as those described above and explanations thereon will be omitted.

When the relation of Tj≦Ts is satisfied by performing the junction temperature Tj reduction processing (step S38), the flow returns to step S31. Subsequently, similar procedures are repeated.

According to fourth operating range limiting method, a calculated loss Lo and the preset loss limit Ls are compared with each other, and when there is a relation of Lo>Ls, the loss Lo reduction processing is performed such that the relation of Lo≦Ls is satisfied. If it is determined by the comparison that there is a relation Lo≦Ls or if the relation of Lo≦Ls is satisfied as a result of the loss Lo reduction processing, a calculated junction temperature Tj and the preset temperature limit Ts are compared with each other, and if there is a relation of Tj>Ts, the junction temperature Tj reduction processing is performed such that the relation of Tj≦Ts is satisfied. Therefore, the operating range of the motor 1 can be expanded by effectively using the switching elements Us-Zs to their maximum temperature limit Max irrespective of the detected temperature Td.

In the foregoing explanation, a case where the three-phase brushless motor 1 is driven by the inverter section 2 has been described by way of example. The aforementioned operating range limiting methods may be applied to a motor control system that comprises an inverter adapted to drive a motor other than the brushless motor, such as reluctance motor or induction motor, to attain functions and advantages similar to those described above.

What is claimed is:

1. A motor control system for driving a motor with a PWM control using an electric power converter such as a three-phase inverter, etc., comprising:
junction temperature calculating means for calculating a junction temperature of a switching element of the electric power converter; and
junction temperature reducing means for comparing the junction temperature calculated by the junction temperature calculating means with a preset temperature limit and for performing junction temperature reduction processing to make the junction temperature equal to or less than the temperature limit when the junction temperature exceeds the temperature limit.

2. A motor control system for driving a motor with a PWM control using an electric power converter such as a three-phase inverter, etc., comprising:
loss calculating means for calculating a loss of a switching element of the electric power converter; and
loss reducing means for comparing the loss calculated by the loss calculating means with a preset loss limit and for performing loss reduction processing to make the loss equal to or less than the loss limit when the loss exceeds the loss limit.

3. A motor control system for driving a motor with a PWM control using an electric power converter such as a three-phase inverter, etc., comprising:
temperature detecting means for detecting a temperature of a switching element of the electric power converter;
junction temperature calculating means for calculating a junction temperature of the switching element of the electric power converter when the temperature detected by the temperature detecting means is between a maximum temperature limit of the switching element and a predetermined temperature which is lower than the maximum temperature limit;
junction temperature reducing means for comparing the junction temperature calculated by the junction temperature calculating means with a preset temperature limit when the temperature detected by the temperature detecting means is between the maximum temperature limit of the switching element and the predetermined temperature which is lower than the maximum temperature limit and for performing junction temperature reduction processing when the junction temperature exceeds the temperature limit;
loss calculating means for calculating a loss of the switching element of the electric power converter when the temperature detected by the temperature detecting means is equal to or less than the predetermined temperature; and
loss reducing means for comparing the loss calculated by the loss calculating means with a preset loss limit when the temperature detected by the temperature detecting means is equal to or less than the predetermined temperature and for performing loss reduction processing to make the loss equal to or less than the loss limit when the loss exceeds the loss limit.

4. A motor control system for driving a motor with a PWM control using an electric power converter such as a three-phase inverter, etc., comprising:
loss calculating means for calculating a loss of a switching element of the electric power converter;
junction temperature calculating means for calculating a junction temperature of the switching element of the electric power converter;
loss reducing means for comparing the loss calculated by the loss calculating means with a preset loss limit and for performing loss reduction processing to make the loss equal to or less than the loss limit when the loss exceeds the loss limit; and
junction temperature reducing means for comparing, when it is determined by said comparison that the loss is equal to or less than the loss limit or when the loss becomes equal to or less than the loss limit by the loss reduction processing, the junction temperature calculated by the junction temperature calculating means with a preset temperature limit and for performing junction temperature reduction processing to make the junction temperature equal to or less than the temperature limit when the junction temperature exceeds the temperature limit.

5. The motor control system according to claim 1, 3 or 4, wherein said junction temperature reducing means carries out the junction temperature reduction processing by means of at least one of a method for reducing a number of switchings per unit time and a method for reducing an electric current flowing through the switching element.

6. The motor control system according to claim 2, 3 or 4, wherein said loss reducing means carries out the loss reduction processing by means of at least one of a method for reducing a number of switchings per unit time and a method for reducing an electric current flowing through the switching element.

7. The motor control system according to claim 5, wherein the number of switchings is reduced by lowering a frequency of a base carrier used for generation of a PWM signal.

8. The motor control system according to claim 6, wherein the number of switchings is reduced by lowering a frequency of a base carrier used for generation of a PWM signal.

9. The motor control system according to claim 5, wherein the electric current is reduced by decreasing a duty cycle of a PWM signal.

10. The motor control system according to claim 6, wherein the electric current is reduced by decreasing a duty cycle of a PWM signal.
